(19) United States
(12) Patent Application Publication
(10) Pub. No.: US 2005/0202375 A1
(43) Pub. Date: Sep. 15, 2005

(54) Method and apparatus for detecting a gravity induced loss of consciousness (G-LOC) state in a pilot

(76) Inventors: Erez Nevo, Natanya (IL); Avi Harel, Yavne (IL)

Correspondence Address: Erez NEVO, P.O.BOX 22891, Baltimore, MD, 21203-4891, US

(21) Appl. No.: 11/034,179

(22) Filed: Jan. 11, 2005

Related U.S. Application Data
(60) Provisional application No. 60/536,801, filed on Jan. 15, 2004.

(51) Int. Cl. G09B 9/08; G09B 19/16

(52) U.S. Cl. 434/59

(57) ABSTRACT

A method and apparatus for detecting the onset of a gravity-induced loss of consciousness (G-LOC) state in a combat pilot wearing a motion-trackable helmet while operating an aircraft, by: storing a reference motion pattern of the helmet for each of a plurality of tasks to be performed by the pilot; tracking in real time the motion pattern of the helmet when worn by the pilot while operating the aircraft; comparing in real time the tracked motion pattern of the helmet with the stored reference motion patterns; and producing a G-LOC state signal when a tracked motion pattern deviates from the stored reference patterns such as to indicate the onset of a G-LOC state.

### RELATED APPLICATIONS

The present application is a continuation of U.S. Provisional Patent Application Ser. No. 60/536,801 filed Jan. 15, 2004, and hereby claims priority therefrom.

### FIELD AND BACKGROUND OF THE INVENTION

The present application relates to a method and apparatus for detecting the onset of a gravity-induced loss of consciousness (G-LOC) state in a combat pilot wearing a motion-trackable element while operating an aircraft.

G-induced Loss of Consciousness

G-induced Loss of Consciousness (G-LOC) in high-performance combat aircraft is not a common incidence but it typically has grave outcome: from 1982 through 1990 there were 18 accidents with 14 fatalities attributed to G-LOC in the United States Air Force (USAF), which constitutes a rate of 2.1 accidents per million flying hours (Lyons T J, Harding R, Freeman J, G-induced loss of consciousness accidents: USAF experience 1982-1990, Aviat Space Environ Med. 1992, 63:60-6). The USAF initiation of an anti-G-LOC training program and the use of improved anti-G gear (e.g. positive pressure breathing) resulted in the gradual decrease of the rate of G-LOC, but have not eradicated it: between 1991-2000 there were still 11 GLOC incidents with 8 fatalities and attributed cost of $174 Million (“USAF GLOC Human Factors: FY91-00”, Luna and White, Headquarters Air Force Safety Center, USAF). It is interesting to note that the annual incidence rate of G-LOC events increased during these years and reached a level of 15-20 incidents per 1 million flight hours in 1999-2000.

Incapacitation due to G-LOC is characterized by an unconscious period (absolute incapacitation) and a subsequent period of confusion/disorientation (relative incapacitation). The sum of the absolute and relative incapacitation periods constitutes the total incapacitation period and represents the overall length of time a pilot would be in uncontrolled flight should G-LOC occur. In centrifuge induced G-LOC episodes, the absolute incapacitation mean period was 16.6 seconds and the subsequent relative incapacitation was 14.5 seconds, resulting in an overall total incapacitation of 31 seconds. The G-LOC incapacitation was dependent on the rate of onset of the +Gz-stress and the +Gz level where G-LOC occurred (Whinnery J E, Burton R R, Boll P A, Eddy D R, Characterization of the resulting incapacitation following unexpected +Gz-induced loss of consciousness, Aviat Space Environ Med. 1987, 58:631-6). The mean time of total incapacitation in training flights was 12.0 seconds (maximum 180) as subjectively estimated by the aircrew (Whinnery J E, +Gz-induced loss of consciousness in undergraduate pilot training, Aviat Space Environ Med. 1986, 57:997-9).

G-LOC episodes could be subdivided into 2 separate types: Type I involving shorter unconsciousness episodes without convulsive movements, and Type II involving longer unconsciousness with more frequently associated dream states and convulsive type movements. Psychological suppression (denial) by pilots that G-LOC had occurred appears to be an important problem in reporting surveys and flying safety, and may indicate that G-LOC rate is higher than reported by studies. Recognition by the pilot that G-LOC has occurred appears to decrease incapacitation times (Whinnery J E, Converging research on +Gz-induced loss of consciousness, Aviat Space Environ Med. 1988, 59:9-11). Thus the identification of the onset of a G-LOC state during flight should initiate a series of stimuli to the pilot (e.g. auditory) in addition to the initiation of an automatic aircraft recovery maneuver.

Obviously, reliable detection of the onset of a G-LOC state in pilots is a key pre-requisite before an automatic aircraft recovery maneuver can be initiated or pilot support stimuli are applied to accelerate the recovery from the relative incapacitation period. Existing efforts in the detection of G-LOC concentrate on the use of physiologic signals to monitor the consciousness level of the pilots:

A straightforward monitoring method to detect G-LOC would be based on detection of a low oxidative status of the brain, the physiologic cause of G-LOC. This determination can be made noninvasively by various monitoring systems. For example, the Oxidative Metabolism Near-Infrared (OMNI) monitor can measure the relative quantities in the brain of hemoglobin, oxygenated hemoglobin, blood volume, and oxidative status of cytochrome c-oxidase. This instrument was successfully tested on subjects in the USAFSAM human-use centrifuge at +3, 4, and 5 Gz with onset rates of 1G/sec (Glaister D H, Current and emerging technology in G-LOC detection: noninvasive monitoring of cerebral microcirculation using near infrared, Aviat Space Environ Med. 1988, 59(1):23-8), but its introduction for monitoring during flight seems to be unlikely in the foreseen future.

Another monitoring method analyzes EEG signals of the brain and detects changes in EEG characteristics due to loss of consciousness (Burns J W, Werchan P M, Fanton J W, Dollins A B, Performance recovery following +Gz-induced loss of consciousness, Aviat Space Environ Med. 1991, 62(7):615-7). This method is limited mainly because of the need to integrate bio-sensors into the flight gear (e.g. helmet), with detachable connections to physiologic monitors, which will enable monitoring of the consciousness level of the pilots during flight. Previous efforts in this direction failed to provide a reliable system that can be easily integrated into the cockpit of standard combat aircrafts.

Thus a need still exists to provide a low-cost, reliable monitoring system that can be easily integrated into existing combat and training aircrafts with minimal changes in the cockpit setup and in safety flight gear.

Head-Mounted Displays

Most helmet-mounted displays (HMD's) involve a number of key components: a visor display on which imagery is projected; cable linking the helmet display to the aircraft's computer system; head trackers to determine the line of sight of the pilot; and quick-release mechanisms so that the aircraft's ejector seat system can function normally. Elbit Systems (Haifa, Israel) has developed a wide range of helmet-mounted sights and displays. Its HMD's are being used on Israeli, Romanian and other countries' combat aircrafts. The largest HMD project is the US Air Force and US Navy program to provide thousands of frontline F-16, F-15, F-22 and F/A-18 fighter pilots with the joint helmet-mounted cueing systems (JHMCS) to allow them to make maximum use of the off-bore sight capabilities of the Raytheon AIM-9X air-to-air missile. These systems are already installed in many combat aircrafts, and will be installed in virtually all future ones. In one of its preferred embodiments, the present invention takes advantage of existing features of HMD's to provide a monitoring system for G-LOC.

High G loads typically occur during air combat maneuvers and during air-ground attack sorties. During these types of combat flight maneuvering, the pilot performs specific tasks that are associated with predictable position and motion of the head—for example viewing the head-up display, searching the air to locate other aircrafts, looking at the ground target or reference landmarks. The patterns of head position and motion during high-G maneuvers can be studied and mapped in aircrafts that are equipped with head tracking system that is a standard component of any HMD. During G-LOC, the head position and motion patterns are substantially different—the head is either fixed in a down-looking orientation, or the head motion follows a non-specific path due to aircraft accelerations or due to G-LOC induced convulsions.

Anti-G Straining Maneuver (AGSM)

The current USAF approved Anti-G Straining Maneuver (AGSM) is the L-1. It combines a regular, 3 second strain (Valsalva) against a closed glottis, interrupted with a rapid exhalation and inhalation (<0.5 seconds), with tensing of all major muscle groups of the abdomen, arms, and legs. Properly done, it adds about 1.5 G's to the G-tolerance levels (around 6 G's for most aircrew). The old M-1 maneuver was essentially the same, but against a partially open glottis, causing the pilot to audibly grunt during the strain (lower intrathoracic pressures achieved so no longer recommended). The US Navy teaches a slight variation of the L-1 called the Hook Maneuver in which the pilots initiate the strain phase by saying “hook” as they begin to strain. This helps ensure a completely closed glottis.

### OBJECTS AND BRIEF SUMMARY OF THE INVENTION

An object of the present invention is to provide a method and apparatus to identify when a combat pilot is in G-LOC based on the difference between the predictable motion pattern during normal operation and the non-specific motion pattern during G-LOC.

Another object of the present invention is to provide such a method and apparatus that can be integrated with an aircraft recovery system to prevent collision with other aircrafts or with the ground, and that can provide stimuli to the pilot to shorten the incapacitation period resulting from G-LOC.

According to one aspect of the present invention, there is provided a method of detecting the onset of a gravity-induced loss of consciousness (G-LOC) state in a combat pilot wearing a motion-trackable helmet while operating an aircraft, said method comprising: storing a reference motion pattern of the helmet for each of a plurality of tasks to be performed by the pilot; tracking in real time the motion pattern of the helmet when worn by the pilot while operating the aircraft; comparing in real time said tracked motion pattern of the helmet with said stored reference motion patterns; and producing a G-LOC state signal when a tracked motion pattern deviates from said stored reference patterns such as to indicate the onset of a G-LOC state.

In the preferred embodiments of the invention described below, the produced G-LOC state signal actuates a visual and/or audible alarm to the pilot, and thereby enables the pilot to manually or orally override the signal. However, if the G-LOC state signal is not overridden by the pilot and persists for a predetermined time interval, an emergency operation is automatically initiated in the aircraft according to the particular aircraft operation then being performed. Examples of various emergency operations automatically initiated for particular aircraft operations are described below.

According to another aspect of the present invention, there is provided apparatus for detecting the onset of a gravity-induced loss of consciousness (G-LOC) state in a combat pilot while operating an aircraft, said apparatus comprising: a helmet to be worn by the pilot while operating the aircraft; a tracking system for tracking the motions of said helmet; and a processor including a database for storing reference motion patterns of the helmet for each of a plurality of tasks to be performed by the pilot; said processor being programmed: (a) to track in real time the motion pattern of the helmet when worn by the pilot while operating the aircraft; (b) to compare in real time said tracked motion pattern of the helmet with said stored reference motion patterns; and (c)to produce a G-LOC state signal when a tracked motion pattern deviates from said stored referenced patterns such as to indicate the onset of a G-LOC state in the pilot.

Two embodiments of the invention are described below for purposes of example.

In one described embodiment, the helmet includes a helmet-mounted display whose motion is tracked by a tracking module which communicates with the processor and aircraft instrumentation via an avionic bus provided in the aircraft.

In a second described preferred embodiment, particularly applicable in aircraft not provided with helmet-mounted displays, the motion of the helmet is tracked by the processor which includes an input from an accelerometer.

Further features and advantages of the invention will be apparent from the description below.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates one form of apparatus constructed in accordance with the present invention particularly useful for aircraft provided with helmet-mounted display systems; and

FIG. 2 illustrates another apparatus constructed in accordance with the present invention particularly useful in aircraft not provided with helmet-mounted display systems.

### DESCRIPTION OF PREFERRED EMBODIMENTS

Unlike physiologic monitoring systems, that require special sensors and monitoring equipment and need complex integration into the flight gear and the cockpit, the method and apparatus of the present invention enable the detection of the onset of a G-LOC state by utilizing equipment that is already installed in many high-performance combat aircrafts.

HMD's require tracking of head position and orientation in order to adjust the symbols position in the display to the spatial orientation of the head. Head tracking is typically done by electromagnetic or by optical positioning systems (e.g. the Elbit\Kaiser Electronics HMD system that provides the basis to the U.S. Joint Helmet Mounted Cueing System (JHMCS) program).

In accordance with a preferred embodiment of the invention described below, the continuous stream of data on head position and orientation can be collected from the avionic bus, along with key flight data (e.g. G level, spatial orientation, altitude, etc.), into a data recorder. Such data is initially collected during training flights and is later processed to formulate the typical patterns of head motion that are associated with specific combat maneuvers. These patterns are stored and used as reference patterns to compare realtime data of head position and orientation and to decide whether this data is within the expected head position\motion envelopes for the specific type of aircraft.

Data recorded from many training flights with different pilots would be processed to define the average envelopes of head position and orientation as function of G-load and potentially other flight variables like aircraft spatial orientation, speed, etc., for the “average” pilot. The system can be improved to enable personalized monitoring of individual pilots, by collecting data for each pilot and by formulation of individual reference envelopes. Furthermore, the monitoring system can include a learning algorithm that continues to collect data for each pilot and continuously adapt the reference envelop for the individual pilot.

The real-time head position and orientation as received from the HMD's tracking system (or from a dedicated head tracking system) is compared with the reference envelopes. If, during high G-loads, a significant deviation from the stored reference envelopes is detected, such as to indicate the onset of a G-LOC state, the system will automatically initiate a warning alarm (visual and\or audio). If the alarm is not reset by the pilot within a pre-determined time, a determination of a G-LOC state will be made, and a sequence of emergency operations will be initiated. This may include, for air-to-ground attack—an automatic terrain-avoidance maneuver; for air-to-air combat training—a radio-transmitted alarm to other aircrafts in the training to notify about the potential G-LOC and an automatic recovery of the aircraft from the high-G maneuver to a steady flight path that will provide the pilot sufficient time to recover. The system can also initiate various operations that may reduce the incapacitation of the pilot—for example to supply 100% oxygen to the oxygen mask, to activate the G-suit in a special mode (e.g. vibrations), to generate visual and audio stimuli to the pilot—all aiming to accelerate the recovery from the unconscious state.

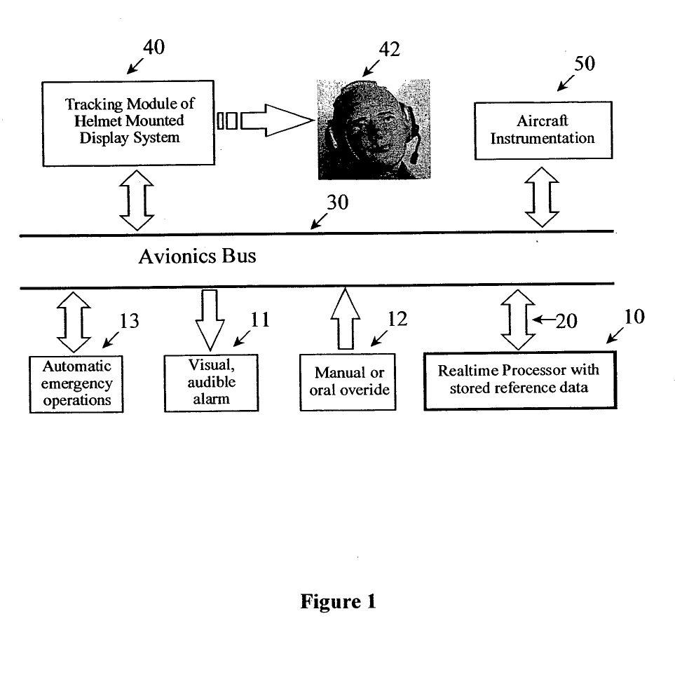

FIG. 1 illustrates one preferred embodiment of the proposed G-LOC detection and response system which includes a realtime processor 10 and a communication line 20 to the avionics bus 30 of the aircraft.

The communication line 20 to the avionics bus 30 provides the location and orientation of the pilot's helmet 42 as received from the tracking module of the HMD 40, and the G-load, altitude, velocity of the aircraft and its spatial orientation (pitch, yaw, roll) as received from the aircraft instrumentation 50 through the avionics bus 30. Passive monitoring of data in the avionics bus in modem aircrafts can be easily implemented by using available hardware modules, and with no safety concerns as it does not interfere with data stream of the bus. However, if this communication cannot be established, the most important variable—the G-level, can be easily provided by including a built-in accelerometer chip in the aircraft instrumentation hardware in accordance with the present invention.

The real-time processor 10 compares the location and orientation of the pilot's head to stored reference motion patterns or envelopes of head position during combat flight. Variables, like altitude, velocity and spatial orientation of the aircraft, may be used with more complex envelopes that take into consideration the flight status of the aircraft. Using a statistical model, the likelihood of having a pilot with the current head position is estimated. Whenever the G-load exceeds a certain pre-defined threshold (e.g. more than 5 G's (in unprotected pilot) or more than 7 G's (in pilot with G-suit) for at least 6-7 seconds, which bring the pilot's brain to an anoxic state), and the likelihood of having a conscious pilot with the current head position is below a pre-defined threshold, a potential state of G-LOC is established.

The pilot must have an override capability, in case he or she is not in G-LOC. So the first operation of the G-LOC detection and response system is to activate a visual and/or audio warning alarm as indicated by box 11 in FIG. 1. The pilot can manually or orally reset this warning, e.g., by using a HOTAS key or an audio command as indicated by box 12 in FIG. 1.

If the system is not reset within a pre-defined time threshold, the system automatically initiates an emergency operation (box 13, FIG. 1), according to the particular aircraft operation then being performed. For example, such an emergency operation may include radio transmission of a warning to other pilots who may be flying in close proximity to the unconscious pilot (e.g. during air combat training) and to ground flight control, and evaluation of the flight path of the aircraft with respect to the ground in order to prevent ground collision.

To achieve these operations, the G-LOC detection and response system should communicate with the avionic bus through the communication channel and transmit the status of “pilot in G-LOC” to the bus 30. The flight control system of the aircraft instrumentation 50 will receive this status and will initiate the automatic recovery maneuver, i.e., the automatic radio transmission of warning. It will also activate various stimuli to the pilot—for example pre-recorded audio messages to the pilot's earphones (“Attention—you are in G-LOC”) or special display on the HMD.

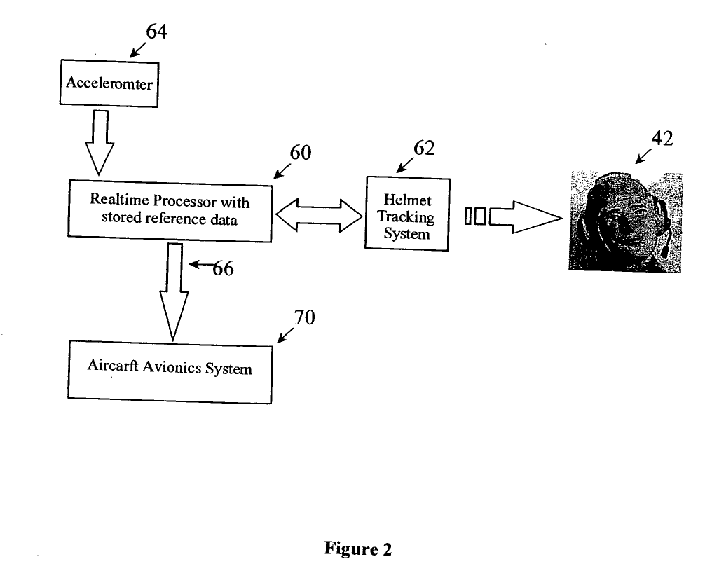

FIG. 2 illustrates another preferred embodiment applicable when the aircraft does not have HMD and data from the aircraft's avionic system cannot be obtained. In this embodiment, a self-contained system includes a processor 60, a helmet tracking system 62 and an accelerometer 64 to monitor head position as function of G-load.

The tracking system 62 provides the location and orientation of the pilot's head. Since the required accuracy is not high, a simple optical or electromagnetic positioning system can be used in the high G environment of combat aircraft. Such commercially available tracking systems are the Aurora magnetic tracking system and the Polaris optical tracking system made by Northern Digital Inc. (Waterloo, Canada).

The processor 60 compares the real-time head position pattern to the stored reference data, as explained above, and if a state of G-LOC is detected the processor sends commands via analog signals or digital communication line 66 to the avionics system 70 of the aircraft to initiate various responses, as described above.

To increase the reliability of G-LOC detection by the system, additional signals can be used. For example, the breathing pattern of the pilot can be easily recorded from the microphone, from the oxygen regulator of the pilot, or from air-flow sensor that is integrated into the oxygen mask of the pilot. During high G-load, the pilot performs anti-G straining maneuver (AGSM) that involves a typical breathing pattern (see Background above and Whitley, Pilot performance of the anti-G straining maneuver: respiratory demands and breathing system effects, Aviat Space Environ Med. 1997 68:312-6). During G-LOC, this voluntary breathing pattern is replaced by an autonomous breathing pattern that is substantially different. The typical breathing sound from the microphone or the airflow pattern in the oxygen mask during AGSM can be recorded and used as an additional variable in the reference envelopes.

While the invention has been described with respect to two preferred embodiments, it will be appreciated that these are set forth merely for purposes of example, and that many other variations, modifications and applications of the invention may be made.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications and sequences identified by their accession numbers mentioned in this specification are herein incorporated in their entirety by reference into the specification, to the same extent as if each individual publication, patent, patent application or sequence identified by their accession number was specifically and individually indicated to be incorporated herein by reference. In addition, citation or identification of any reference in this application shall not be construed as an admission that such reference is available as prior art to the present invention.

1. A method of detecting the onset of a gravity-induced loss of consciousness (G-LOC) state in a pilot wearing a motion-trackable helmet while operating an aircraft, said method comprising:
storing a reference motion pattern of the helmet for each of a plurality of tasks to be performed by the pilot;
tracking in real time the motion pattern of the helmet when worn by the pilot while operating the aircraft;
comparing in real time said tracked motion pattern of the helmet with said stored reference motion patterns; and
producing a G-LOC state signal when a tracked motion pattern deviates from said stored reference patterns such as to indicate the onset of a G-LOC state.

2. The method according to claim 1, wherein said produced G-LOC state signal actuates a visual and/or audible alarm to the pilot.

3. The method according to claim 2, wherein said G-LOC state signal is manually or orally overridable by the pilot, and wherein, upon the persistence of said G-LOC state signal for a predetermined time interval, an emergency operation is automatically initiated in the aircraft according to the particular aircraft operation then being performed.

4. The method according to claim 3, wherein the particular aircraft operation then being performed is an air-to-ground attack maneuver; and wherein said emergency operation automatically initiated in the aircraft is a terrain avoidance maneuver.

5. The method according to claim 3, wherein the particular aircraft operation then being performed is an air-to-aircombat maneuver; and wherein said emergency operation automatically initiated in the aircraft is a radio-transmitted alarm to other aircrafts.

6. The method according to claim 3, wherein said emergency operation automatically initiated is or includes the recovery of the aircraft from a high-G maneuver to a steady-flight path.

7. The method according to claim 3, wherein said emergency operation automatically initiated is or includes increasing the concentration of oxygen supplied to the pilot.

8. The method according to claim 3, wherein said emergency operation automatically initiated is or includes actuating the pilot's G-suit to a special mode.

9. The method according to claim 3, wherein said emergency operation automatically initiated is or includes generating visual, audio or other sensorial stimuli to the pilot such as to accelerate recovery from an unconscious state.

10. The method according to claim 1, wherein said helmet includes a helmet-mounted display, and wherein the motion of said helmet is tracked by a tracking module for said helmet-mounted display communicating with the aircraft instrumentation via an avionics bus.

11. The method according to claim 1, wherein the motion of said helmet is tracked by a processor which includes an input from an acceleromotor.

12. Apparatus for detecting the onset of a gravity-induced loss of consciousness (G-LOC) state in a combat pilot while operating an aircraft, said apparatus comprising:
a helmet to be worn by the pilot while operating the aircraft;
a tracking system for tracking the motions of said helmet; and
a processor including a database for storing reference motion patterns of the helmet for each of a plurality of tasks to be performed by the pilot;
said processor being programmed:
(a) to track in real time the motion pattern of the helmet when worn by the pilot while operating the aircraft;
(b) to compare in real time said tracked motion pattern of the helmet with said stored reference motion patterns; and
(c) to produce a G-LOC state signal when a tracked motion pattern deviates from said stored referenced patterns such as to indicate the onset of a G-LOC state in the pilot.

13. The apparatus according to claim 12, wherein said helmet includes a helmet-mounted display; and wherein the motion of said helmet-mounted display is tracked by a tracking module which communicates with said processor and aircraft instrumentation via an avionic bus provided in the aircraft.

14. The apparatus according to claim 12, wherein the motion of said helmet is tracked by said processor which includes an input from an acceleromotor.

15. The apparatus according to claim 12, wherein said apparatus further comprises:
a visual and/or audible alarm actuated by said G-LOC state signal;
and an override system manually or orally actuated by the pilot for overriding said G-LOC state signal.

16. The apparatus according to claim 15, wherein said processor is programmed such that upon the persistence of said G-LOC state signal for a predetermined time interval, an emergency operation is automatically initiated in the aircraft according to the particular aircraft operation then being performed.

17. The apparatus according to claim 16, wherein the particular aircraft operation then being performed is an air-to-ground attack maneuver; and wherein said emergency operation automatically initiated in the aircraft is a terrain avoidance maneuver.

18. The apparatus according to claim 16, wherein the particular aircraft operation then being performed is an air-to-air combat maneuver; and wherein said emergency operation automatically initiated in the aircraft is a radio-transmitted alarm to other aircrafts.

19. The apparatus according to claim 16, wherein said emergency operation automatically initiated is or includes the recovery of the aircraft from a high-G maneuver to a steady-flight path.

20. The apparatus according to claim 16, wherein said emergency operation automatically initiated is or includes increasing the concentration of oxygen supplied to the pilot.

21. The apparatus according to claim 16, wherein said emergency operation automatically initiated is or includes actuating the pilot's G-suit to a special mode.

22. The apparatus according to claim 16, wherein said emergency operation automatically initiated is or includes generating visual, audio or other sensorial stimuli to the pilot such as to accelerate recovery from an unconscious state.
